(19) United States
(12) Patent Application Publication
(10) Pub. No.: US 2025/0061444 A1
(43) Pub. Date: Feb. 20, 2025

(54) SYSTEMS AND METHODS FOR CRYPTOGRAPHIC INFRASTRUCTURE

(71) Applicant: ROYAL BANK OF CANADA, Toronto (CA)

(72) Inventors: Venkatadri Kaushik KOMANDUR, Toronto (CA); Goran ZUGIC, Toronto (CA); Andrew SUTTON, Toronto (CA); Christopher Côté SRINIVASA, Toronto (CA)

(21) Appl. No.: 18/807,973

(22) Filed: Aug. 17, 2024

Related U.S. Application Data
(60) Provisional application No. 63/533,251, filed on Aug. 17, 2023.

(51) Int. Cl. G06Q 20/36; G06Q 20/38

(52) U.S. Cl. CPC G06Q 20/3674; G06Q 20/3825; G06Q 20/3829

(57) ABSTRACT

A computer implemented approach is proposed as a computer infrastructure that is configured such that users can access digital resources managed by an institution, using self-custodied cryptographic material. The cryptographic approach allows them to prove their identities, encrypt data, and decrypt data through specific computer interactions based in cryptography. A dynamic approach to cybersecurity is proposed using an adaptive cryptographic verification approach using a combination of multi-party cryptography techniques and opportunistic idle computing resource usage.

### CROSS-REFERENCE

This application is a non-provisional of, and claims all benefit including priority from, U.S. Application No. 63/533,251, filed 17 Aug. 2023, entitled “SYSTEMS AND METHODS FOR CRYPTOGRAPHIC INFRASTRUCTURE.

This application is incorporated by reference in its entirety.

### FIELD

Embodiments of the present disclosure relate to the field of cryptography, and more specifically, embodiments relate to devices, systems and methods for improved cryptographic infrastructure for supporting enhanced multi-party credential data objects configured for coordinated decentralized processing.

### INTRODUCTION

Credentials provide a mechanism for authenticating users who wish to access protected resources via an electronic communication network. Typically, these credentials are a username and a password (“something only the user knows”), in cases where multi-factor authentication is supported such authentication is augmented by an additional factor (“something only the user has”) such as a numeric code sent to the user via text messages or email or generated via specialized authenticator token software or hardware.

The problems with credential-based authentication are that: (1) users forget usernames and passwords Malicious actors can guess usernames and passwords, (2) Malicious actors can generate passwords for weakly protected resources (e.g. using pre-image attacks, rainbow attacks, social engineering/phishing attacks), (3) malicious actors can also spoof cellular phones or hack email accounts to intercept assumed secure delivery of tokens for multi-factor authentication, and (4) blockchain-based accounts cannot be directly accessed using credential-based systems. Credential-based access usually requires mapping of credentials to cryptographic keys in a “warm wallet” introducing a security vulnerability to the security model and significantly weakening user's control over their assets. This has occurred in respect of a collapse of a Fintech organization that allegedly lost control over its keys.

Another technical problem with protected resources, especially those that operate on decentralized networks, is that the securing protocols used may be transparent and observable by third parties. Malicious third parties are then able to estimate accurately the difficulty of launching a cyberattack and procure computing resources sufficient to overwhelm cybersecurity defenses.

### SUMMARY

A scalable computing architecture using one or more decentralized physical computer servers operating in concert is described in various embodiments herein that provides a practical, adaptive approach using sharded cryptographic keys to enable differing computing weight levels adaptive for varying levels of available computing resources and/or transaction characteristics while also providing a mechanism for improved key recovery. In the proposed architecture, custodial systems and subscriber (e.g., user) systems are configured for coordinated operation as orchestrated by a coordination computing system.

The coordination computing system provides a specialized coordination layer that controls operation types (e.g., between a “heavyweight” approach and a “lightweight” approach) based on a combination of available computing power in the network, as well as characteristics of a proposed transaction. The difference between the “heavyweight” and the “lightweight” approach is in the amount of computational processing power required for the underlying cryptographic computations, as described in embodiments herein, and in some variants, the balance between the heavyweight and the lightweight approach can be adaptive based on transactional load and/or computational performance of the decentralized network. The heavyweight approach, relative to the lightweight approach, requires additional signing events on a transaction, and thus has a heavier computational cost associated with the computational activities relating to the transaction. The technical benefit of using the heavyweight approach is an increased resilience against multiple system compromise, at the cost of a significantly increased number of computational operations.

The scalable computing architecture operates in conjunction with a proposed computer implemented approach such that users can access digital resources managed by an institution, using self-custodied cryptographic material. The cryptographic approach allows them to prove their identities, sign and verify data, encrypt data, and decrypt data through specific computer interactions based in cryptography. The approach also allows users to retain access to resources despite loss of self-custodied cryptographic material.

The approach utilizes special cryptographic approaches that are adapted for multi-party considerations and multi-party approaches, and the devices associated with the parties can be adapted for conducting specialized cryptographic exchanges with one another. As described in more specific embodiments, lightweight verification cryptographic approaches are also proposed in relation to tokenization approaches to provide a practical approach for improving computational performance during run-time.

Lightweight approaches are useful especially for a highly scaled computing environment, such as one operating at an industry scale where millions of accounts and potentially millions of transactions occur daily, and the system not only needs to be robust from a cybersecurity perspective, but also able to conduct operations having regard to limited computing resources and processing time available (e.g., to conduct cryptographic tasks within a context dependent reasonable time-frame).

Institutions can provide users with guarantees as well as proofs that resources have been accessed only after the appropriate level of authorization has been received from the user of their designated proxies. For operations where the institution is required to access a digital resource without the direct authorization of the user, institutions can assure regulators and other stakeholders that such access to digital resources can be managed by the institution acting in concert with the user's designated proxy substituting for the user. This could require every user to designate and authorize a suitable proxy.

The approaches proposed are useful in practical applications, including for providing cryptographic approaches for proving identity (e.g., allows users to prove who they are to an institution), and practical use cases, including providing user authentication to gain access to an institution's software application, providing user authentication to gain access to parts of a condo building, providing user authentication to lock or unlock a vehicle, or managing access to resources on a permissioned blockchain-allows users to manage digital assets issued by an institution on permissioned blockchains utilizing account or token-based frameworks.

In the context of blockchain/distributed ledger technologies, the approaches can also be useful for accessing permissioned blockchain resident securities managed by an institution, managing access to cryptocurrency-based assets-allowing users to manage cryptocurrencies and other assets such as non-fungible tokens on public blockchains secured using cryptographic keys.

Various embodiments of approaches proposed herein can be used for buying and selling cryptocurrencies (e.g., Bitcoin or Ethereum), buying and selling non-fungible tokens (NFTs), cryptocurrency staking for proof-of-stake cryptocurrencies, or verifying credentials-allows users to offer proof of credentials to verifiers. These can be used for a practical set of use cases, including, for example, the tokens can be used for digital driver's licenses, digital passports, proof of car or house insurance, proof of vehicle registration, educational transcripts.

The approaches can also be used for securing digital property-allowing users to encrypt data so it can only be decrypted using their self-custodied keys, among others, such as for encryption and decryption of digital files to facilitate secure storage. This digital property can include various types of “digital cash residing on a ledger”.

These approaches can be practically implemented on a computational computer system, for example, by having computer devices that interoperate with one another. The subscriber devices can include smartphones or other portable electronic computers, and the verifier devices can include cloud or on-premises devices, such as servers in a data center, a set of interconnected distributed resources, among others. The subscriber proxy devices can similarly include cloud or on-premises devices, such as servers in a data center, a set of interconnected distributed resources, among others.

The verifier devices can operate as special purpose machines that can include computer appliances (e.g., rack-mounted appliances) that are coupled onto a message bus that are specifically configured to handle cryptographic operations relating to the message flows, such as read/write/authenticate mechanisms.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a Venn diagram showing example roles, according to some embodiments.

FIG. 2 is a logical infrastructure block diagram showing example components of a system, according to some embodiments.

FIG. 3A-3D show a method diagram showing a sequence for an authentication flow that is initiated by a subscriber, according to some embodiments.

FIG. 4A-4E show a method diagram showing a sequence for a read-only signing and verification flow that is initiated by a subscriber, according to some embodiments. This includes an initial signing flow, as well as a verification flow.

FIG. 5A-5F show a method diagram showing a sequence for a write-only signing and verification with authentication flow that is initiated by a subscriber, according to some embodiments. This includes an initial signing flow, as well as a verification flow.

FIG. 6 is a method diagram showing a distributed key generation flow, according to some embodiments.

FIG. 7 is a computer system diagram showing an example computer device that can be used to implement some of the claimed embodiments.

FIG. 8 is an example special purpose machine that can be transformed using machine interpretable instruction sets, according to some embodiments.

### DETAILED DESCRIPTION

To address problems noted above in respect of passwords, the technology industry has evolved to “password-less” authentication schemes based on cryptographic methods (e.g., Passkeys (Passkey Authentication)). While current password-less approaches solve some of the problems introduced by credential-based authentication, there remain technical problems. Some problems that remain unsolved and some new problems introduced are: (1) users cannot lose their cryptographic keys and have them recomputed transparently to the broader authentication solution, (2) passkey solutions often imply reliance on a key-backup solution. This key backup introduces further security vulnerabilities. (3) Passkey solutions are not compatible with blockchain-based ledger access today for most public blockchains, and (4) finally, passkeys continue to be a single-signature solution. Digital signatures generated by a passkey can only be generated by a single private key. This makes them unsuitable or limited for secure multi-party computation use cases where multiple parties are required to generate keys independently of each other without reliance on a trusted third party (distributed key generation) and subsequently jointly sign a message digitally. Passkeys, as they are currently implemented, are also not designed for use cases involving the encryption and decryption of payloads. Their focus is primarily on authentication.

The crypto-asset approaches have also introduced cold, hot and warm wallets to manage access to blockchain-based assets. Hot and warm wallets are susceptible to hacking at providers. Keys in cold wallets if lost, imply loss of access to assets. The only mitigation for such total loss of access is wallets that support a recovery mnemonic (e.g., a random collection of words that a user must retain securely), but not all wallets support these and a user may lose the mnemonic as well.

A scalable computing architecture using one or more decentralized physical computer servers operating in concert is described in various embodiments herein that provides a practical, adaptive approach using sharded cryptographic keys to enable differing computing weight levels adaptive for varying levels of available computing resources while also providing a mechanism for improved key recovery.

In the proposed architecture, custodial systems and subscriber (e.g., user) systems are configured for coordinated operation as orchestrated by a coordination computing system.

The solution outlined in various embodiments herein has the following attributes which overcomes certain problems and limitations of credential-based authentication and passkeys. It uses threshold cryptography and a set of proprietary protocols and can be adapted for distributed key generation involving a plurality of participants. A cryptographic approach can then be utilized to enable the secure storage of cryptographic material with users, providers of the solution, and third party stakeholders, and the re-computation of the user's keys in the event of loss can be conducted.

The cryptographic data objects can include single or combined signatures involving just the user or the multiple parties, enabling encryption and decryption of a payload by the user. An institution is able to authorize every single access request and further cryptographically sign approved access requests from users.

In the event of a loss of keys, an institution can leverage a trusted third party authorized by the user to help in the recovery of access to user accounts in the event of loss of keys, and help in the performance of actions on the account in the event the institution is compelled to without the user's approval (e.g., in the case of a court order or for regulatory compliance). An example of a situation where the institution could be compelled could be for a “digital cash on ledger” type system, where a court order is transformed into a computational query data object and transmitted as a data message to a verifier computational system (e.g., a financial institution). The verifier computational can transmit the court order computational query data object or extracted portions thereof in a message to an appointed custodial system that acts as a subscriber/user proxy, which can authorize or decline such requests automatically based on a set of guidance logic from the subscriber/user. The appointed custodial system can be a trusted third party system that can include a specialized cybersecurity company or high security trusted third party, that provides the trusted third party custodial service.

The court order computational query data object can be used thus potentially for querying accounts relating to verifier that fit a specific criteria (e.g., all accounts having transactions greater than a threshold size) as represented in a logical query instruction request, or could be specifically targeting a small number of accounts or a specific account (e.g., for account related to John SMITH, a known criminal or politically exposed person). A benefit of the proposed approaches described herein is that the authentication data objects as shared between the different parties are adapted to cross-integration and interoperation between the different devices to support the various use cases.

In operation, the approach includes providing a “Universal Digital Wallet” type approach that enables an institution (the Verifier) to provide its customers (Subscribers) with the ability to secure generate and store cryptographic material and the ability to securely perform cryptographic operations used to access resources protected by the verifier (Protected Resources) via the cryptographic material.

The coordination computing system also describes a specialized coordination layer that controls operation types (e.g., between a “heavyweight” approach and a “lightweight” approach) based on a combination of available computing power in the network, as well as characteristics of a proposed transaction.

The difference between the “heavyweight” and the “lightweight” approach is in the amount of computational processing power required for the underlying cryptographic computations, as described in embodiments herein, and in some variants, the balance between the heavyweight and the lightweight approach can be adaptive based on transactional load and/or computational performance of the decentralized network. Different levels of weight can be implemented, for example, a number of computing operations can be increased, establishing different variations of heavyweight (e.g., light heavyweight, regular heavyweight, superheavyweight).

The heavyweight approach, relative to the lightweight approach, requires additional signing events on a transaction, and thus has a heavier computational cost associated with the computational activities relating to the transaction. The technical benefit of using the heavyweight approach is an increased resilience against multiple system compromise, at the cost of a significantly increased number of computational operations. The ratio of read and write operations can be controlled, such that the ratio of read to write operations can be modified for a duration of time.

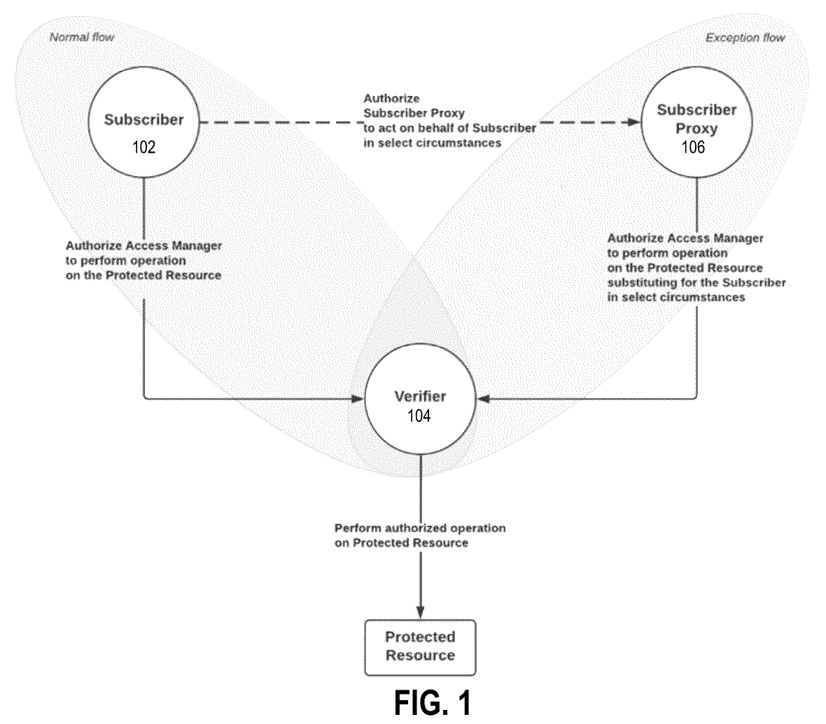

Effectively, a policy and coordination engine is configured as a controller process (e.g., a specialized load balancing daemon process) that modifies computational complexity both in respect of transactions that must have a high level of security (e.g., high value transaction/transfer between untrusted accounts), and transactions that could have a higher level of security that can be set opportunistically based on load. A technical benefit from a cybersecurity perspective is that it is difficult for a third party observer that is malicious to effective gauge a difficulty level of cyber attack, and thus they are less able to prepare/attain attacking computational resources. With each increase in complexity (e.g., each additional signature required), essentially, an additional computing system needs to be compromised. Given the limited amount of time available to conduct a breach, the chances of a full compromise is thus proportionally decreased. In some embodiments, a complexity jitter is implemented to make it more difficult for a malicious user to be able to predict a complexity level. FIG. 1 is a Venn diagram showing example roles, according to some embodiments. As shown in drawing 100 in FIG. 1, subscribers 102 have sole custody of cryptographic material required to perform operations initiated by them. Typically, this material would be stored on a device controlled by the user. In the event of loss of this cryptographic material, the solution also permits a user (subscriber 102) to regain access to their resources. Backup of Subscriber-custodied keys is expensive and often involves a backup facility in addition to the device hosting the cryptographic keys. The solution does away with (e.g., does not require) the backups, because lost Subscriber keys can be substituted with keys recomputed mathematically. In operation, subscriber keys can be regenerated using partial key shards held by custodians or trusted verifier third parties, and different security levels are possible. The key regeneration approach is conducted as noted below by a coordination and policy engine that is configured to perform the steps required to regenerate the subscriber key, and thus, computational load is offloaded from the subscriber/user's device.

Credential-less (or passwordless) access is provided to remote computation servers eliminating the need for additional secure storage of username-password credentials. With its reliance on cryptographic material stored securely on a client device used to access remote servers, the solution eliminates the need for Subscribers to remember and backup usernames and passwords. This is in common with solutions such as Passkey, but the primary difference between this solution and Passkey in its current form is that lost Passkey cryptographic material has to be restored from a backup.

The approach also allows for multi-factor authentication comprised of biometric authentication as well as cryptographic materials in a secure enclave that eliminate the need for 2^{nd} factor solutions such as random numbers sent via email or text.

Accordingly, the proposed approach can thus potentially avoid expensive and unsafe second factor authentication mechanisms by ensuring 2 levels of authentication in the system: for example, (1) a biometric authentication that verifies a potential Subscriber has access to the cryptographic keys on their device (to ensure it is the correct Subscriber performing the action), and (2) cryptographic keys mapped to a Subscriber's real world identity on the backend to verify that a Subscriber is who they assert they are.

The proposed approach also enables institutions to respond to instructions such as court orders without the participation of subscribers. This is achieved by involving a 3rd party (the Subscriber Proxy 106), who is authorized by the Subscriber to co-operate with the Verifier 104 in the event certain legal or business conditions become true (such as court orders, regulatory compliance, or commercial reasons). Depending on the context, the terms subscriber, user, or client may be used interchangeably.

What the proposed approach enables from a subscriber 102 perspective is that the system can generate public-private cryptographic key pairs on a device controlled by the subscriber, with the subscriber having sole custody of the private keys. The key pair are linked to other key pairs generated at a Subscriber Proxy 106 and Verifier 104 via a multiparty computation algorithm for distributed key generation.

The subscriber 102 can also digitally sign, using cryptographic keys controlled solely by them (private keys), electronic messages to be sent over electronic communication networks to remote computers (servers), encrypt, using their own public key, data to be sent over electronic communication networks to remote computers (servers) where this data may be stored, or decrypt, using keys controlled solely by them (private keys), data received from remote computers (servers) where such data is stored, over electronic communication networks. The subscriber 102 can also jointly sign electronic messages to be sent over electronic communication networks to remote computers (servers). Private keys controlled solely by the Subscriber and private keys controlled solely by the Verifier(s) will be used in this operation. The subscriber 102 can also jointly encrypt, using relevant public keys controlled by the Subscriber and the Verifier(s), data to be sent over electronic communication networks to remote computers (servers) where this data will be stored.

The subscriber 102 can also jointly decrypt, using relevant private keys controlled by the user and institution(s), data received from remote computers (servers) where such data is stored, over electronic communication networks. Private keys controlled solely by the Subscriber and private keys controlled solely by the Verifier(s) will be used in this operation.

The subscriber 102 can also recover the ability to perform the above cryptographic operations, in the event of cryptographic material loss by the Subscriber (by re-generating appropriate cryptographic material on the customer's device), Verifier (by re-generating appropriate cryptographic material on the customer's device or via backup storage mechanisms), or Subscriber Proxy (by re-generating appropriate cryptographic material on the customer's device or via backup storage mechanisms).

From the perspective of the Subscriber Proxy 106, the Subscriber Proxy is able to generate public-private cryptographic key pairs on a device controlled by them, with them having sole custody of the private keys. The key pair are linked to other key pairs generated at a Subscriber 102 and Verifier 104 via a multiparty computation algorithm for distributed key generation. The Subscriber Proxy 106 can also jointly sign electronic messages to be sent over electronic communication networks to remote computers (servers). Private keys controlled solely by the Subscriber Proxy 106 and private keys controlled solely by the Verifier(s) 104 will be used in this operation, and maintain a record of authorizations provided by the Subscriber 102 (authorizing them to act on their behalf for specified operations).

From the perspective of the Verifier 104, the Verifier 104 can generate public-private cryptographic key pairs on a device controlled by them, with them having sole custody of the private keys. The key pair are linked to other key pairs generated at a Subscriber 102 and Subscriber Proxy 106 via a multiparty computation algorithm for distributed key generation. The Verifier 104 can also jointly sign electronic messages to be sent over electronic communication networks to remote computers (servers). Private keys controlled solely by the Subscriber or Subscriber Proxy and private keys controlled solely by the Verifier(s) will be used in this operation. The Verifier 104 can provide verification that signed requests originated from a particular Subscriber 102, or Subscriber Proxy 106 or combination consisting of Subscriber 102+Verifier 104, or Subscriber Proxy 106+Verifier 104.

The Verifier 104 can protect a resource (Protected Resource) associated with a Subscriber 102 by validating all incoming requests from the Subscriber 102 and Subscriber Proxy 106 using a policy (consisting of a set of rules) for Subscriber identity and access rules for the Protected Resource. Protection involves permitting policy-based access to the Protected Resource as well as revoking it (temporarily or permanently). The Verifier 104 can also initiate the refreshing of cryptographic materials at the Subscriber 102, Subscriber Proxy 106 as well as within itself to ensure good practices in key management.

The Verifier 104 maintains a mapping between cryptographic keys used by Subscribers 102 and Subscriber Proxies 106 and the real-world legal identity of the Subscriber 102, and maintains a mapping between Subscribers 102 and the identity and access policies associated with them. The Verifier 104 also maintains a mapping between a Subscriber 102 and the Subscriber Proxy 106 associated with them (for each key pair generated by a Subscriber 102). The Verifier 104 can also maintains an audit trail of all access requests by a Subscriber 102 or Subscriber Proxy 106.

After a Subscriber 102 has been authenticated successfully by the system, it generates a bearer token that is securely stored on the subscriber's client device. This token ensures that the Subscriber 102 initiates expensive cryptographic computation on the server side only once until the subscriber wishes to perform a write operation. All read operations subsequent to the initial authentication rely on the bearer token being verified in a lightweight “cryptographic” manner. Similarly, after a write request, a new bearer token is generated which can be reused for all subsequent read operations until the next write operation.

Read-only transactions can be designated as a lightweight transaction, for example, and a write request can be designated as a heavyweight transaction.

In another variation, a coordination and policy engine as described herein is utilized for dynamically determining the transactional type, which can be a combination of the transactional type/characteristics of the transaction, as well as based on the computational load of the system. The coordination and policy engine is configured to manage/maintain a data structure having data fields and data values representative of a ratio between lightweight and heavyweight computations. In some embodiments, the lightweight and heavyweight computations may also have sub-groupings with different impacts on the ratio (e.g., light heavyweight and superheavyweight).

An example ratio could be 5:1 lightweight vs. heavyweight (5 reads per 1 write), and that could decrease as the system balances towards a heavyweight direction of the spectrum (e.g., if the heavyweight computations require a significantly increased amount of computation relative to the lightweight computations). A computational load monitor may receive a load metric value (measured using a proxy value such as CPU load, a number of buffered verification requests, transaction times as measured by latency, among others) as an input into the coordination engine that can be used for opportunistic adjustments to the read to write ratio. During low load periods, for example, the ratio can be shifted to a 1:1 through selective usage of lightweight and heavyweight approaches. Other ratios are possible. In some embodiments, a minimum ratio is maintained despite heavy load. For example, the system can maintain a 5:1 as a minimum threshold despite serious degradations in transactional throughput as the baseline level of cybersecurity resilience.

The coordination engine can also dynamically adjust the ratio in response or in anticipation of a higher level of cybersecurity risk, for example, as automatically monitored through proxy measurements and metrics from access/attack logs. During times or in response to a greater number of logged events, the ratio can be adjusted at the cost of performance to increase resilience proactively.

All of these proposed methods are aimed at performance optimizations for a highly scalable system (i.e., not every operation needs to be heavy). In some embodiments, a technical benefit of a dynamic system is further established by not providing a static indication to outside observers as to what “weight” is applied to each interaction, providing a level of cybersecurity breach difficulty obfuscation in an attempt to make the system more difficult to be practically breached by a malicious third party while managing available computing resources.

Accordingly, the cybersecurity resilience level can be configured in a “greedy” manner in respect of available computing resources, for example, as measured by transaction/computer operation throughput on a distributed decentralized network, opportunistically raising security and computational complexity during times of low load to increase resilience by using otherwise idle computational resources. The balance between heavy and lightweight operations can thus be balanced and coordinated to achieve an overall hardened network while being mindful of maintaining a satisfactory level of computational performance in the network.

When computational resources are estimated to be needed, either through monitoring expected load or a number of incoming transactions, the computational resources can be “released” by reducing the computational complexity, thus freeing computational resources for transaction processing.

A bearer token is used in all methods, but for methods relating to policy engine/transaction type or computational load, it can be used only verifying that the user has passed authentication. In some embodiments, the bearer token can be configured for use for two purposes: verifying user is authenticated+distinguish between read (light) and write (heavy) crypto operations.

The bearer token contains the following data:
Subscriber ID that includes ID of the application that is being accessed and ID of the subscriber's device (mobile phone).
Session ID. Session is an interaction between Subscriber 102's mobile wallet and the verifier's wallet that directly interacts with the application.
Nonce that is a randomly generated value by the Secure Enclave on the Subscriber 102's mobile phone.
Subscriber 102's signature on the (Subscriber ID, Session ID) pair which is denoted as the challenge.
In some embodiments, the bearer token also includes the following data: a policy data object (app id, txn type, client type); and/or a computational load (CPU usage, memory, I/O, network). These can be used to support a policy and weight determination, as described herein. The bearer token can either have a weight provided in the policy data object (e.g., minimum weight for this type of transaction must be heavyweight), or the weight can be dynamically determined. For example, for a simple read operation, the weight can simply be noted as dynamic. In some embodiments, both a minimum weight and a dynamic weight can be noted. For example, in a second simple read operation, the weight can be noted as 2/4+, requiring at least 2 shards but 3/4 and 4/4 are acceptable.

Initially, when the Subscriber 102 is being authenticated after submitting an authentication request to the verifier's wallet, the Session State Management component of the Verifier 104's wallet generates Session ID and Subscriber ID and returns them to the Subscriber 102's mobile wallet as a challenge. After receiving the challenge, the subscriber mobile wallet generates a nonce via the Secure Enclave component. Nonce is a randomly generated value that is used with the challenge to prevent replay (man-in-the-middle) attacks.

The challenge (Subscriber ID, Session ID) received from the Verifier 104's wallet and generated nonce are signed by the subscriber's wallet with subscriber's private key and send back to the verifier's wallet as a bearer token.

The Verifier 104's wallet Session Validator component validates the token and if the validation is successful the subscriber will be successfully authenticated and get the access to the application. This authentication is valid for the lifespan of the session regardless of the application request (read/write) performed.

However the read and write flows have their own specifics which details are specified in the flow (sequence) diagrams (“Read Only Flow” and “Write Only Flow” respectively). The read requests are optimized since they rely on the bearer token holding Subscriber 102's signature which verification is sufficient for giving application access to the Subscriber 102 based on the read signature policy requesting only subscriber's signature.

The write requests also rely on the bearer token holding the Subscriber 102's signature but its verification is not sufficient since the write signature policy also requires the verifier's signature to be generated and then combined with the subscriber's signature before the write request signed with the combined signature is sent to the application.

In a more complex embodiment, there can be multiple Verifier 104 computing systems, each holding a cryptographic shard such that multiple signatures are required to conduct a particular transaction, as noted above. The multiple signatures can include a combination of different instances of Verifier 104, or subscriber proxy device 106 computing devices.

The write request flow can be expanded as noted below into differentiated classes of heavyweight. As described further herein, the distinction between lightweight, and different classes of heavyweight can then be utilized through an automated policy engine running on a coordinator layer to determine how a request is handled.

Where a request can be dynamically handled either as a lightweight (e.g., the read only flow above), or a heavyweight (“write only flow”), the system is configured to be able to automatically select between the lightweight flow and the heavyweight process flow (or in some embodiments, different types of heavyweight process flows) to maintain a processing ratio or a range of processing ratios in an effort to opportunistically utilize available computing processing power while balancing computing requirements to maintain a satisfactory level of throughput performance (e.g., as measured by a load signal proxy). As described further below, the range of processing ratios can be maintained to always be greater than a minimum threshold (e.g., 1:5) such that there is a minimum level of cybersecurity for certain types of transactions, but available compute can be automatically used to increase security whenever possible. To further thwart adversary malicious systems, in some embodiments, a random jitter is introduced into the heavyweight modification determinations so that the adversary malicious systems cannot easily estimate the amount of computing processing power required to conduct a cyber attack.

In this example, the Subscriber 102's signature may be considered one shard, while each Verifier 104 can be considered another shard. As described in examples herein the, in this more complicated example, different heavyweight flows can be implemented by requiring that multiple Verifier 104 signatures are required using their corresponding cryptographic shard. In this more complex embodiment, each additional signature required is an additional hurdle and requires increased computational complexity, but also has corresponding increases in terms of cybersecurity and protection against multiple breaches. The “heavy” ness of a particular heavyweight approach can be based on the total number of signatures required, and in an example where there are 3 Verifier 104, there can be a light heavyweight requiring 2/4 shards, a medium heavyweight requiring 3/4 and a super heavyweight requiring 4/4 shards. This can be coupled with Subscriber Proxy 106 shards, etc.

It is important to note that with each additional verifier signature required, the computational complexity increases significantly and there may be a corresponding impact on load. As load increases, there will be a saturation point in which overall system performance will begin to suffer, as exhibited, for example, as increased delay between transactions, among others. The number of transactions and the associated or estimated complexity can be coupled together to establish an overall estimate of load, and during times of low load, there may be computational idle power that can be harnessed for adaptive cybersecurity hardening as described herein.

Note: Subscriber 102 and Subscriber Proxy 106 can be referenced interchangeably in the above section relating to the bearer token.

The read requests are optimized since they rely on the bearer token holding Subscriber 102's signature which verification is sufficient for giving application access to the subscriber based on the read signature policy requesting only Subscriber 102's signature is what is referred to as the lightweight cryptography.

The write requests also rely on the bearer token holding subscriber's signature but its verification is not sufficient since the write signature policy also requires the verifier's signature to be generated and then combined with the subscriber's signature before the write request signed with the combined signature is sent to the application. That is the “heavyweight cryptography” since it includes two signature shares (instead of one signature share) that have to be combined.

Conditional joint signatures can be included in read/write requests. Successful write requests are signed first by the Subscriber 102 and then by the Verifier 104. The solution contains logic to ensure that the Verifier 104 signs only if (1) the Subscriber 102 has signed, (2) the Subscriber 102's signature is valid, and (3) the Subscriber 102's status on the solution is “active” (i.e. a Subscriber 102 who has been granted authority to perform the requested operation).

These checks ensure that two cryptographic operations, signature of the write request message by the Verifier 104 as well as combining of Verifier 104 and Subscriber 102 signatures of the write request message are performed only for Subscribers that have otherwise been deemed by the solution to perform the write request. This is in contrast to traditional use of threshold signatures in wallets where the parties in the threshold sign first, the signatures are combined and the validations are performed last. As noted herein, the combining can include multiple Verifier 104 signatures which can be handled, for example, ideally by non-correlated Verifier 104 nodes.

The specific cryptographic operations, in an example, can be represented in the form of persistent smart contracts that are maintained on a blockchain that is capable of Turing Complete compute processing. These smart contracts can be validated and approved by underlying parties. An example practical implementation of the read only (lightweight), write only (heavyweight and/or different types of heavyweight) operations is to have a separate party approved smart contract that is configured for receiving signature inputs and automatically conducting downstream operations if and only if the correct number of signatures are received. These operations can include giving (read/write) access to the protected resource, regenerating other key shards, among others.

A coordination engine as noted below is configured to route authorizations through a selected smart contract of the plurality of smart contracts, and the coordination engine may be configured to adaptively select different smart contracts as noted herein representing different weights based on a target maintained ratio or range of ratios depending, for example, on policy considerations and/or load considerations.

The adaptation can be automatic and configured, in some embodiments, to vary with load considerations to opportunistically or greedily utilize available compute during low load times to drastically improve cybersecurity resilience by increasing a security level of even transactions that would otherwise suffice by utilizing a lightweight approach.

By introducing a random jitter, the adaptation can become even more robust to attack. In some embodiments, the coordination engine attempts to maintain an acceptable target ratio range or a minimum target ratio. The ratio is automatically increased during reduced load.

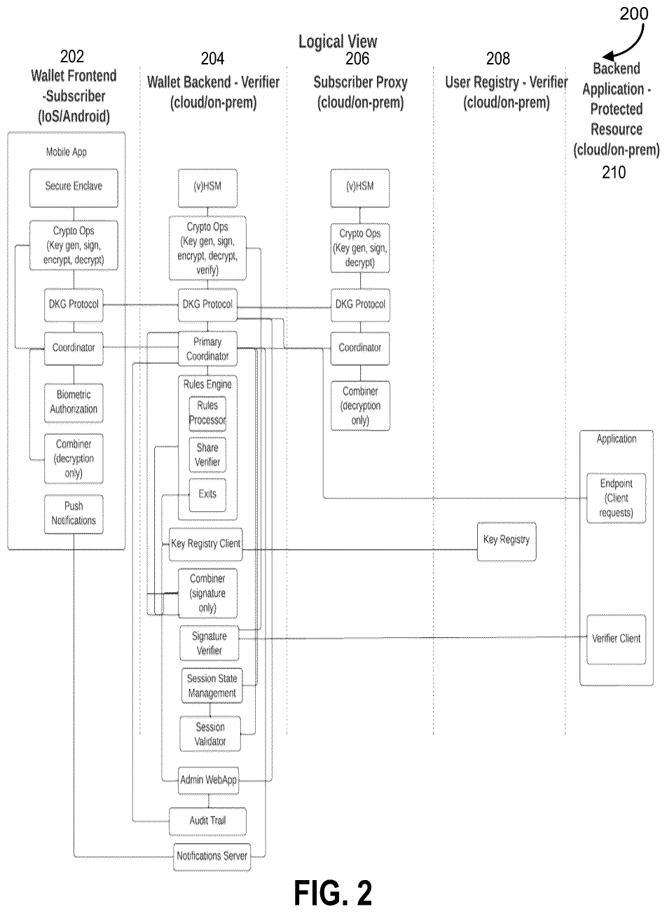

FIG. 2 is a logical infrastructure block diagram showing example components of a system, according to some embodiments. In system 200, a logical view is shown of example logical components that can be implemented in a combination of hardware and software. As shown in FIG. 2, there is a Wallet Frontend 202, that, for example, can be provided in the form of a mobile application running on a Subscriber 102's smartphone. The Wallet Frontend 202 is electronically coupled to a Wallet Backend 204 that can be controlled by the Verifier 104.

A Subscriber Proxy 106 can be provided in the form of a subscriber proxy cloud or on-premises infrastructure 106 having a set of functionality that can be accessed, for example, through an application programming interface (API). The Verifier 104 can maintain a user registry 208 in the form of a key registry. Ultimately, the cryptographic tokens are used to protect a backend application/protected resource 210.

A Distributed Key Generation (DKG) Protocol is proposed as a variation of the distributed threshold key generation protocol that includes the following steps:
1. A subscriber submits a threshold key generation request from a Mobile Wallet via its Coordinator component including his/her user ID. The request is sent to the Primary Coordinator of the Backend Wallet.
2. Primary Coordinator of the Backend Wallet retrieves threshold security parameters from the vHSM component via Crypto Ops Key Generation operation. It also retrieves public parameters and policy (threshold and signature shares' combination) for the type of the subscriber that submitted the request. The parameters include public parameters, a security parameter and threshold t in the (t, n)-threshold scheme where t<n. There are n parties holding distinct key shares and any or specific subset(s) of t parties can issue a valid signature
3. Primary Coordinator sends back the parameters (from the previous step) tuple to the requesting subscriber's Mobile Wallet's Coordinator
4. Mobile Wallet Coordinator calls Crypto Ops key generation operation to generate
   a. Secret key (SK) which is the private key related to the user's share,
   b. Verification key (VK) that is used to verify signatures created by the share secret key (SK),
   c. Global public threshold key (PK)
5. Stores all keys in the secure enclave via Crypto Ops component
6. Shares PK, VK with the Backend (threshold) Wallet
7. The backend threshold wallet collects all counterparties' verification keys (VK) and global public threshold key (PK) and stores them in corresponding subscribers' records in the Subscriber Registry
8. Backend Wallet notifies Mobile Wallet user about the threshold key generation

The secure enclave is a dedicated component integrated into the smartphone systems on chip. It is isolated (e.g., segregated or having limited functionality or interactivity) from the main processor and provides an extra layer of security and keeps sensitive data secure even when the smartphone's processor kernel is compromised.

The secure enclave is configured to perform the following operations:
Key generation
   Key generation performs cryptographic key generation either through
      a regular key generation process or
      as a part of a distributed threshold key generation
Signing
   Generate either regular or threshold share digital signatures based on Public Key Infrastructure (PKI) cryptography
Encryption
   Encrypt data using a public key. The public key can be either a regular PKI public key or a threshold public key
Decryption
   Decrypt data using a private key. The private key could be either a regular PKI private key or a combined threshold private key
Generate nonces for updating challenges needed for client authentication

The private key share, challenge from the server including session ID and client ID (back-end application ID and client's device ID) are stored in the Secure Enclave.

Crypto Operations Component (API Interface) is a component that provides an API interface for performing the following operations via Secure Enclave (please see previous Section):
Key generation
Signing
Encryption
Decryption
Nonce generation

A coordinator computing engine component is proposed that is a critical computing infrastructure for controlling adaptive operation of the proposed computational architecture and approach. In particular, the coordinator computing engine is configured to dynamically manage and assign to each transaction a weight level that will be used to assess whether a heavyweight or lightweight approach is going to be applied.

There can be multiple coordinator computing engines that operate together, including a global and a local coordinator computing engine that apply global and local rules. For example, the local coordinator computing engine may be configured to track local load on local nodes, while the global coordinator can be configured for applying global policy (e.g., all transactions greater than a threshold value will always require n/n super heavyweights, while certain transactions can have dynamic weight (e.g., n/5 shards required)).

A maximum security level as identified by either the local coordinator and the global coordinator can thus be applied for the computation requirements for the transaction. In some embodiments, this application includes the selective use of different configured smart contracts that are each configured to execute different weights of transactions. The smart contracts can be selectively interacted with through sending data messages to or otherwise interacting through exposed APIs.

The coordinator computing engine component is configured for:
Communications with the backend Primary Coordinator
Client authentication via session ID
   Upon successful biometric local authentication, submits an authentication request to backend Primary Coordinator and receives response with a challenge including session ID and client ID that includes application ID and client's device ID.
   Store the challenge in the Secure Enclave
   Request signing of the challenge including session ID and client ID
   Sends signed challenge request to the Wallet Backend.
Retrieve session ID and client ID from the Secure Enclave
Generate new nonces for the requests' authentication on the Wallet Backend
Request signing of (client ID, session ID, nonce) and read/write request payload by the Secure Enclave via Crypto Ops.
Generate either a threshold key share or regular PKI-based key
Request signing of a request with a regular PKI signature
Encryption via Crypto Ops encrypt operation using global threshold public key
Decryption of the encrypted messages via Combiner that is performing combined threshold decryption

The Combiner component (Decryption only) is configured to combine all threshold decryption shares form all required parties into a combined decryption ciphertext that is used to decrypt a message encrypted with the threshold global primary key.

The Biometric Authenticator component is configured to verify a user's identity using their unique biological traits such as either fingerprints or facial features.

The Push Notifications component is configured for pushing notifications from the Mobile App to the backend Notifications Server for submission to registered recipients.

The Wallet Backend 204 component resides either on premise or in the cloud.

A vHSM is a hardware or software-based security module for generating and storing keys and other secrets and performing cryptographic operations using the keys including the PKI key generation, signature creation, signature verification, encryption, and decryption:
Key generation
   Key generation performs cryptographic key generation either through
      a regular key generation process or
      as a part of a distributed threshold key generation
   Retrieval of security parameters from the vHSM
Signing
   Generate either regular or threshold share digital signatures based on Public Key Infrastructure (PKI) cryptography.
Encryption
   Encrypt data using a public key. The public key can be either a regular PKI public key or a threshold public key.
Decryption
   Decrypt data using a private key. The private key could be either a regular PKI private key or a combined threshold private key
Verify
   Verifies regular PKI-based signatures

The Crypto Ops is a component that provides an API interface for performing the following operations via the vHSM:
Key generation
Signing
Encryption
Decryption
Signature verification

The Primary Coordinator component is responsible for.
External communications with the threshold counterparties' Coordinators and applications
Internal Wallet Backend communications with Wallet Backed components including Rule Processor, Session State Management, Session Validator, and IAM Key Registry
Challenge state validation for clients' authentication
Update server-side session objects for users' authentication
Check compliance with read and write policies
Create combined signature requests
Signing via Crypto Ops sign operation that either generate a regular PKI signature or a share threshold signature
Encryption via Crypto Ops encrypt operation using global threshold public key.
Decryption of the encrypted messages via Combiner that is performing combined threshold decryption

A Rules Engine is provided to process threshold keys' generation, and can be used to define how lightweight or heavyweight crypto operations are distributed (e.g., by transaction and/or application type), signing and verification policy rules and client's validation via the following components:
Rules Processor
   Threshold key generation, signing and verification rules, and user validation regarding its status (active/inactive) and retrieval of policies which user is linked to. The rules include but they are not limited to the threshold t in the (t, n)-threshold scheme where t<n. There are n parties holding distinct key shares and a specific or any subset of t parties can issue a valid signature.
Share Verifier
   Verifies a threshold share signature
Exits
   Calls Key Registry Client that interacts with Key Registry component in order to validate the user

The Combiner (signing only) component is configured to combine all threshold signature shares form all required parties into a combined threshold signature. It provides this service to the Rules Engine component during the signing process of the user request.

The Signature Verifier component is configured to verify combined threshold signatures for applications via Crypto Ops Verify function. The Crypto Ops Verify function executes vHSM signature verify operation on either:
a single shared signature (for the Rules Engine Share Verify) or
combined threshold signature for this (Signature Verifier) component.

Session State Management component performs operations that manage states of users' session objects. The following operations are supported by the Session State Management component:
Generate session ID during initial processing of the user's authentication request
Generate client ID during initial processing of the user's authentication request. The client ID is comprised of application ID that user is accessing and an ID of the device (e.g., smartphone) which the user accesses the application from.
Creation of the server-side session object that is a key-value pair with client ID as a key and session ID and an array of nonces as value. Nonces are generated by clients, and they are used to prevent replay attacks.

To prevent the bearer token being generated once per request, a session state manager component along with necessary data structures and state management algorithms keeps track of valid bearer tokens that the server will permit. This reduces expensive computation on the server side in terms of token creation including repetitive CPU intensive cryptographic operations.

The Session Validator component is configured to validate session state for a current client's session. The validation of the session state includes the following steps:
1. Get a session object via client ID
2. Compare client-side Session ID with Session ID in server-side Session Object
3. Compare client-side nonce with all nonces from server-side Session Object (in nonce [ ] array)

The Key Registry component is configured for managing user records that include
User ID
Global threshold public key
User's verification key
Threshold policies
Active/Inactive status
Verification keys tuple including all threshold parties' verification keys

The Audit Trail component is configured to maintain a record of all access requests. A detailed audit trail along with necessary data structures is maintained for all authentication, read and write requests-successful and unsuccessful. The trail includes which entities have signed successful requests.

The Notifications Server is a component running in the backend that is configured to provide notification service for Mobile Wallet and Wallet Backend. Either email messages or text messages notifications can be supported, for example.

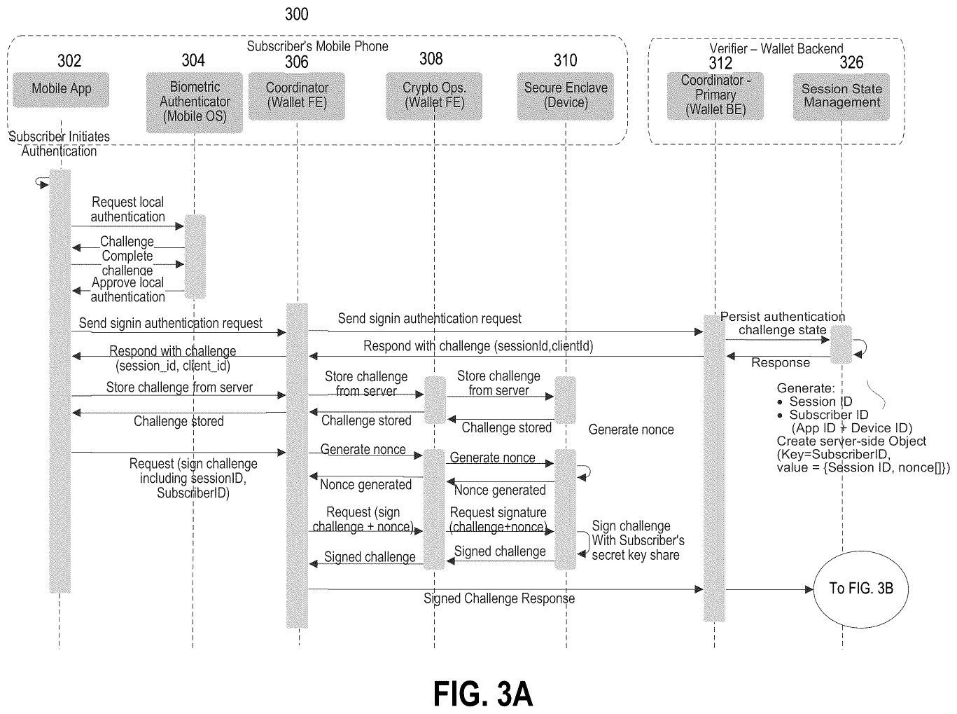

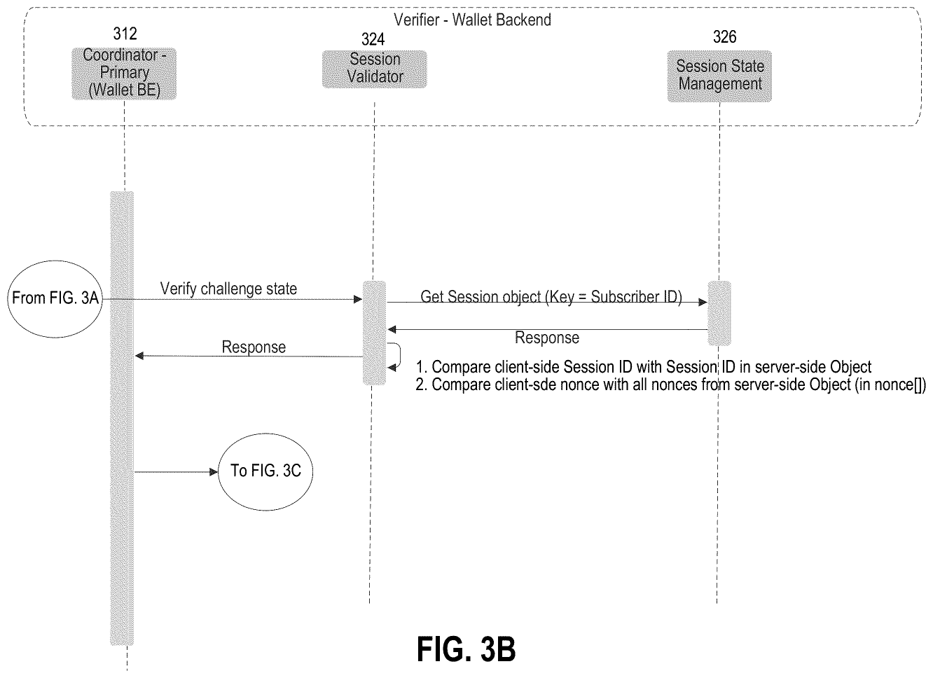

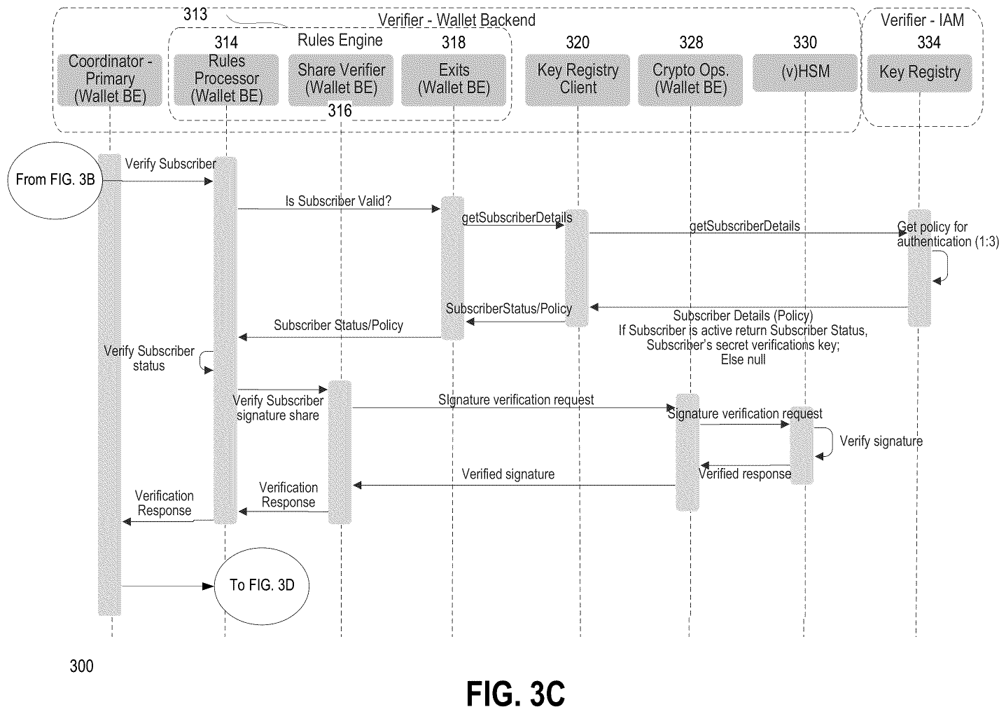

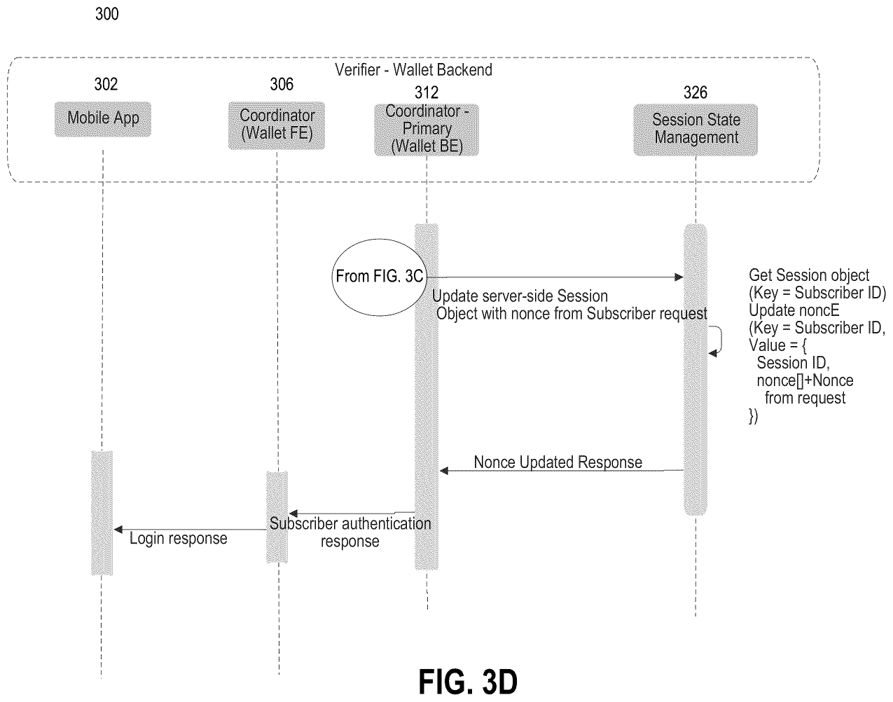

FIG. 3A, FIG. 3B, FIG. 3C, and FIG. 3D show a method diagram showing a sequence for an authentication flow that is initiated by a subscriber, according to some embodiments.

In method 300, an approach is proposed where a Subscriber 102 initiates a authentication on a Mobile App 302, which first requests and completes a biometric challenge/response using a Biometric Authenticator 304.

According to this embodiment, once the biometric challenge/response has been successfully completed, the Mobile Wallet 302 sends an authentication request, which is forwarded by the Wallet FE Coordinator 306 and the Wallet BE Coordinator Primary 312, before being handled by Session State Management 326. A session- and client-specific challenge is then created, which is stored by the Wallet FE Coordinator 306, the Wallet FE Crypto Ops 308, and the Secure Enclave 310.

This embodiment then allows for Requests to be sent from the Mobile App 302 to the Wallet BE Coordinator Primary, through the Wallet FE Coordinator 306. In this embodiment, this is performed by generating a request-specific nonce in the Secure Enclave 310, and then signing the request, using the Crypto Ops 308 and the secret key share stored in the Secure Enclave 310.

The signed request is transmitted to the Wallet BE Coordinator Primary 312, which then proceeds through a series of verification steps to verify the authentication on the request. The Wallet BE Coordinator Primary 312, in some embodiments, is an engine running on a persistent data process such as a daemon process that is configured to automatically balance computational difficulty level through modifying what type of verification process is needed for a particular operation (e.g., lightweight, or different flavors of heavyweight) by controlling smart contract connections. The Wallet BE Coordinator Primary 312 can parse a desired transaction through the bearer token to review the policy requirements for the desired underlying operations. A minimum threshold can be determined, and where there is available increases in difficulty (weight classes above the minimum weight), it can configured for opportunistic cyber hardening automatically by greedily utilizing available compute.

The Wallet BE Coordinator Primary 312 can be coupled with an input receiver coupled to a compute load observer process that generates an input signal corresponding to a load amount value. If the load amount value is less than maximum load amount value, this may be indicative that there is available computing power that is idle across the system.

The load, from a practical implementation perspective, may be representative of system load through an overall transaction load of the system. Load can be monitored directly through a number of different potential sources, such as an estimate based on a total number of transactions being requested divided by an estimated maximum throughput, it can be estimated directly by way of processor load, or it can be indirectly estimated through monitoring the time required for an average transaction or a test dummy transaction to be completed (the higher time, the greater estimated load). The Wallet BE Coordinator Primary 312 can be configured to maintain a minimum complexity threshold without violating any policy requirements, and in some embodiments, automatically increase difficulty levels of otherwise lower security transactions by increasing them into increasingly heavyweight crypto operations even if not absolutely necessary by policy by acting as a switch to indicate with smart contract operation a particular transaction is routed to.

The Wallet BE Coordinator Primary 312 operates to change signature request requirements dynamically. According to this embodiment, the request signature is first verified by passing the challenge state to the Session Validator 324, which interacts with Session State Management 326 to validate the request signature. Validation can include, depending on the weight, multiple signature verifications based on smart contract requirements.

A Rules Engine, which in some embodiments consists of a Rules Processor 314, a Share Verifier 316, and an Exits 318, is able to verify the subscriber, by getting subscriber details from the Key Registry Client 320, which in turn interacts with the Key Registry of the IAM Verifier 334. The Rules Engine also interacts with the Wallet BE Crypto Ops 328, and the (vHSM) 330 to verify the subscriber's signature.

Finally, the Wallet BE Coordinator Primary 312 updates the Session State Management 326 with an updated Session Object, which might include for example nonce details from the user request. The Subscriber Authentication Response can be returned to the Wallet FE Coordinator 306, and which may then return a Login Response to the Mobile App 302.

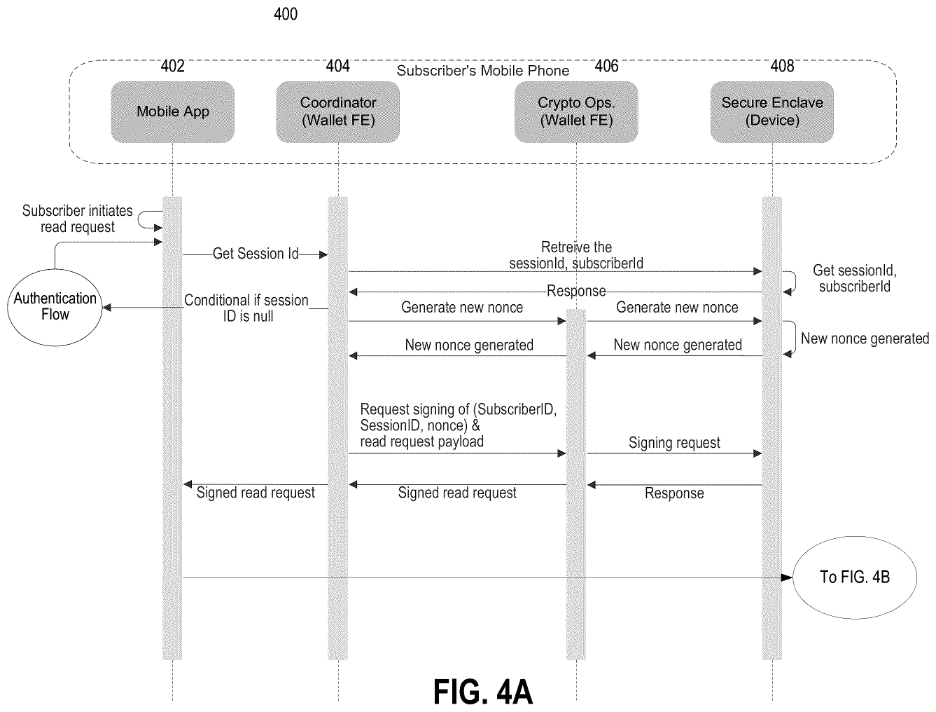

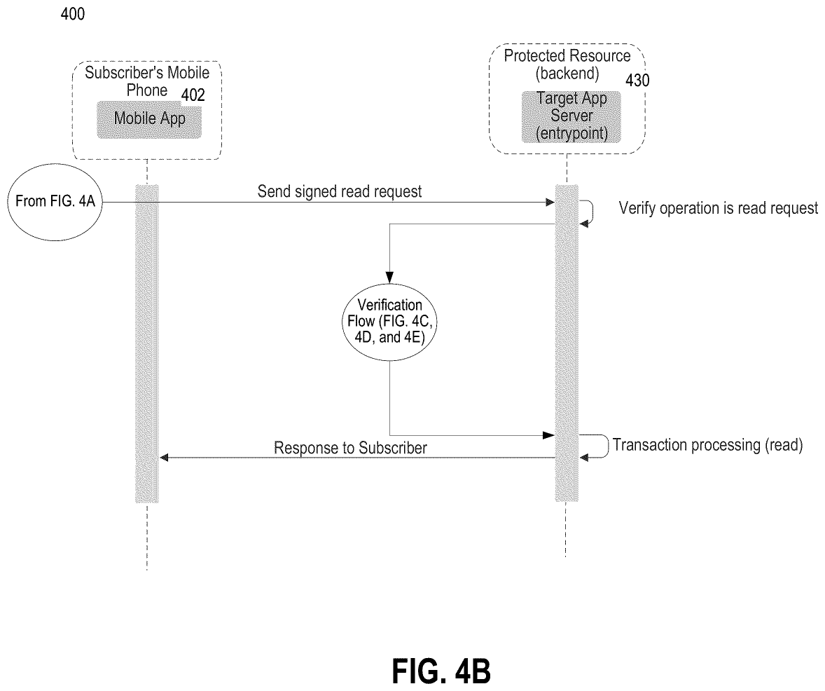

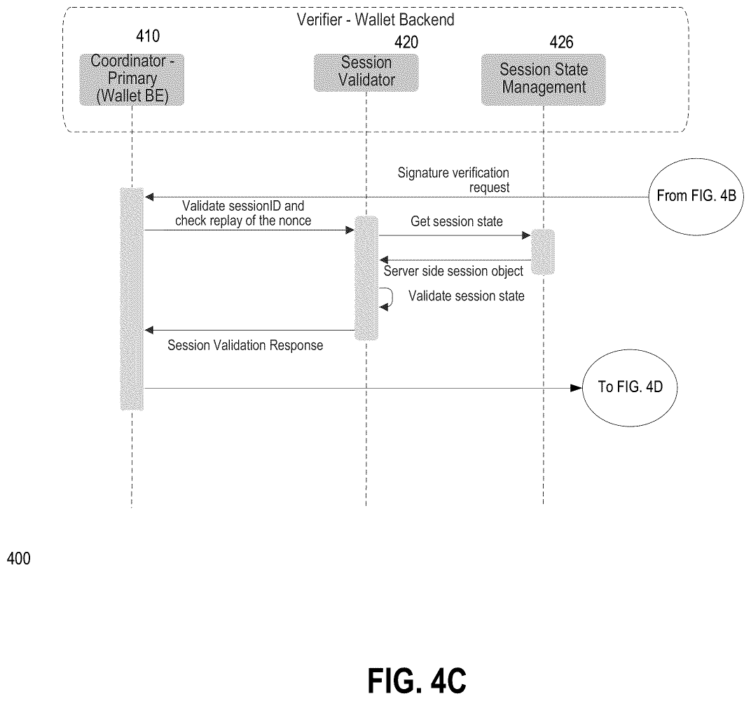

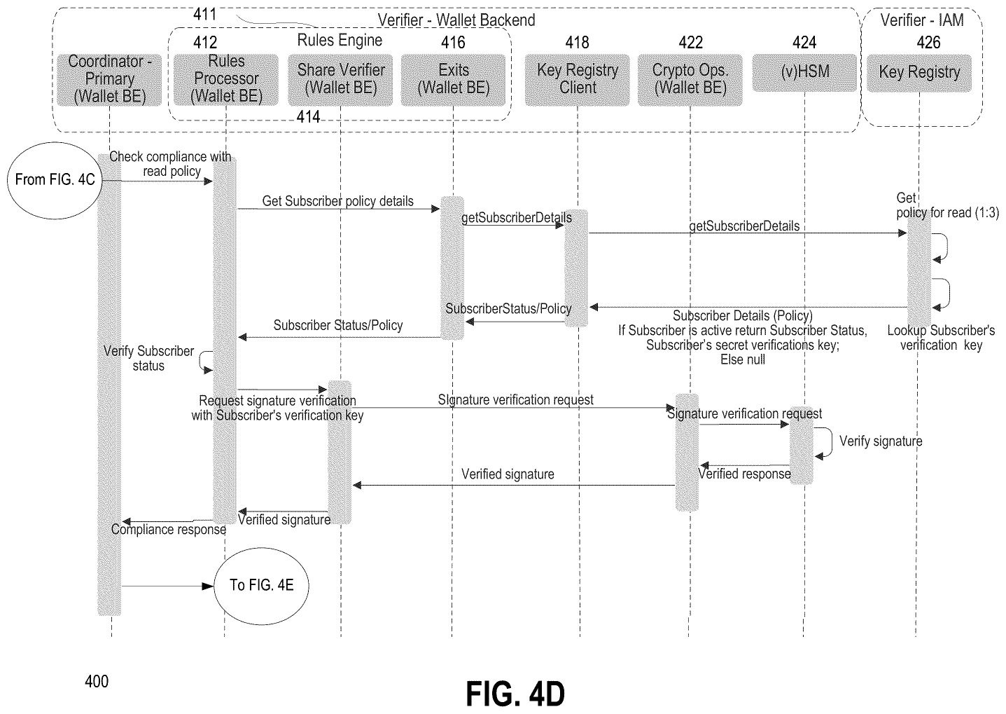

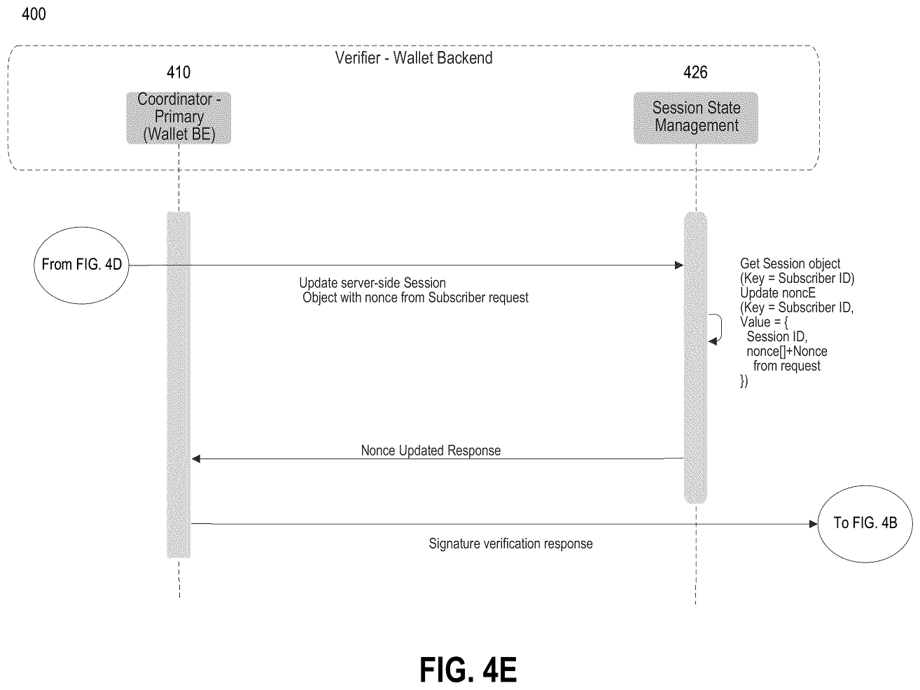

FIG. 4A, FIG. 4B, FIG. 4C, FIG. 4D, and FIG. 4E show a method diagram showing a sequence for a read-only signing and verification flow that is initiated by a subscriber, according to some embodiments. This includes an initial signing flow, as well as a verification flow.

In method 400, an approach is proposed where a Subscriber 102 works with a Verifier 104's wallet backend to obtain access to a protected resources on the backend for ultimately providing a read-only transaction processing to generate a response object in response to the Subscriber 102.

The method is initiated by the Subscriber using the Mobile App 402. The Mobile App 402 retrieves a Session ID and Subscriber ID from the Secure Enclave 408, or conditionally obtains these values from an Authentication flow if they are not defined. A new nonce value is obtained via the Wallet FE Crypto Ops Module 406, using the Secure Enclave 408, and these values are used to sign a read request.

In this embodiment, the read request is transmitted to a protected backend resource, the Target App Server 430, which verifies the operation is read request, before passing the operation on to the Wallet BE Coordinator Primary 410. This then proceeds to validate the session, using the Session Validator 420, which is able to get session state from the Session State Management 426.

This method, according to some embodiments, will then use the Rules Engine 411 to check compliance with a read policy, such Rules Engine consisting of a Rules Processor 412, a Share Verifier 414, and an Exits 416 module. These interact with the Key Registry Client 418 to get subscriber details, which is in turn able to look up those details in an IAM Verifier Key Registry 426. The lookup response from this latter service will indicate whether the user is inactive, which is indicated using a null response. The Rules Engine 411 also interacts with the Wallet BE Crypto Ops 422, and the (vHSM) 424 to verify the subscriber's signature.

Finally, the Wallet BE Coordinator Primary 410 updates the Session State Management 426 with an updated Session Object, which might include for example nonce details from the user request. The Signature verification response can be returned to the Target App Server 430, which can then process the read transaction, and return a response to the Mobile App 402.

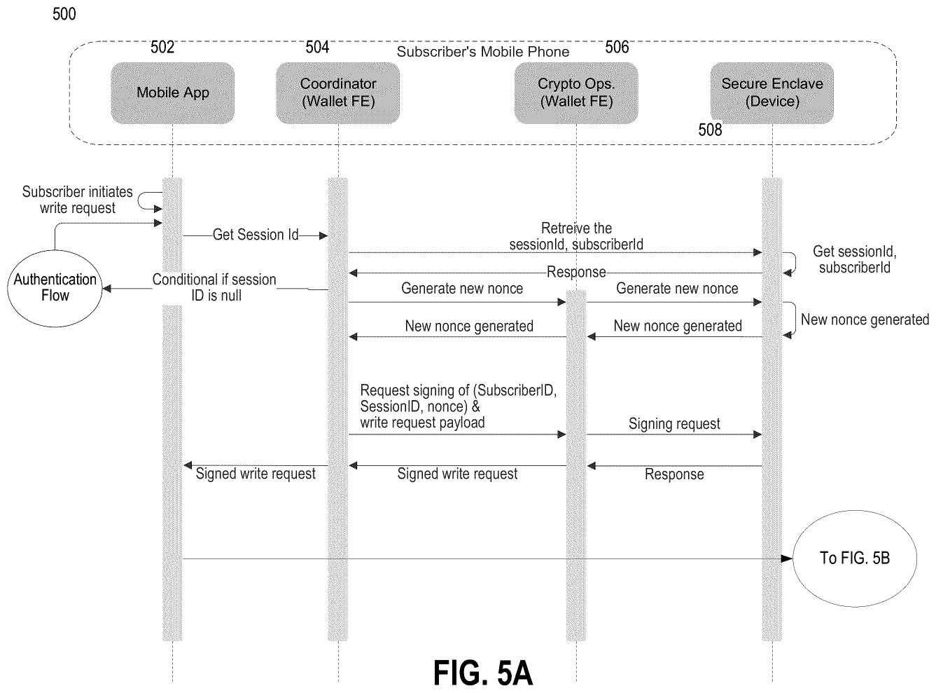

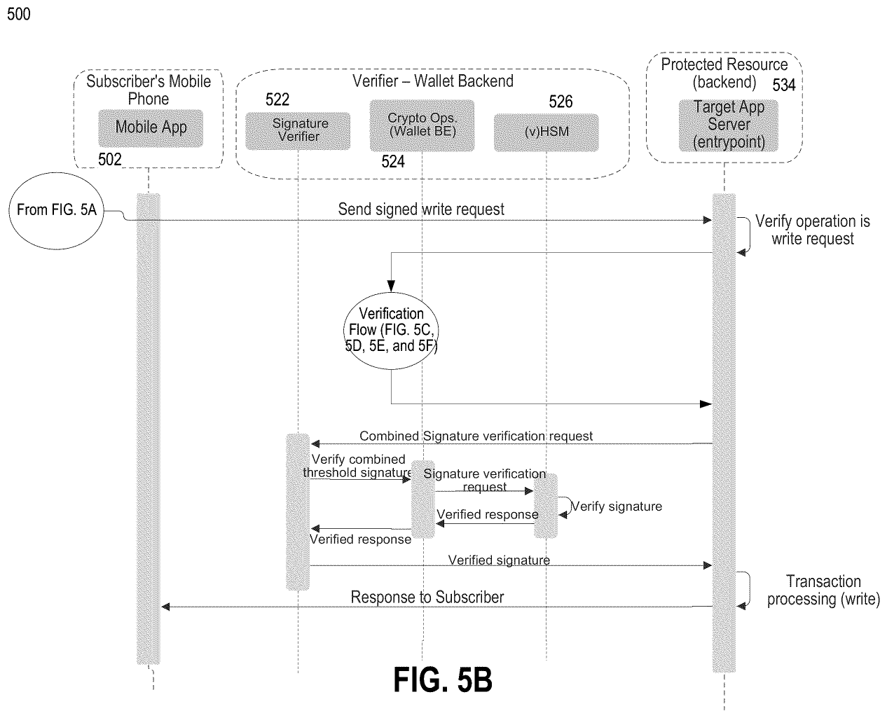

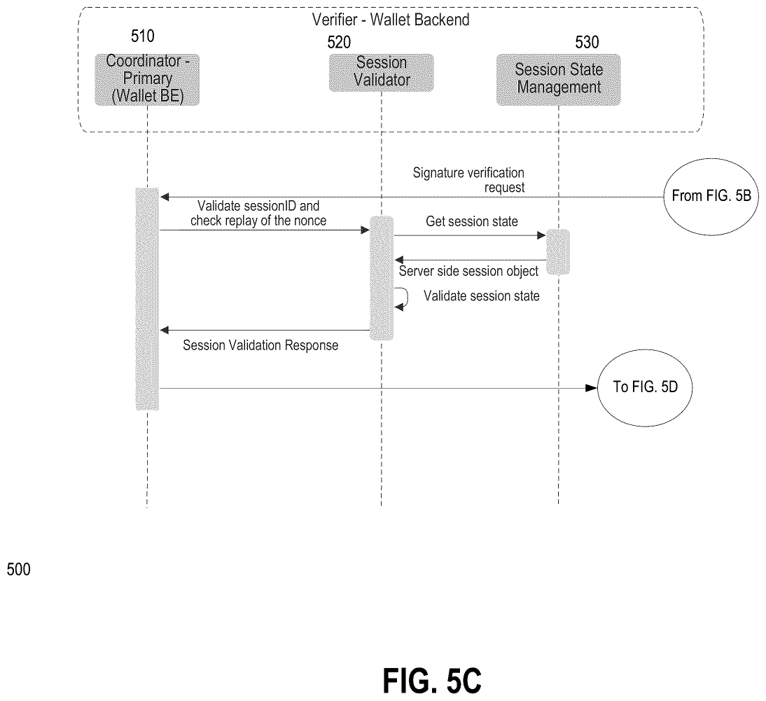

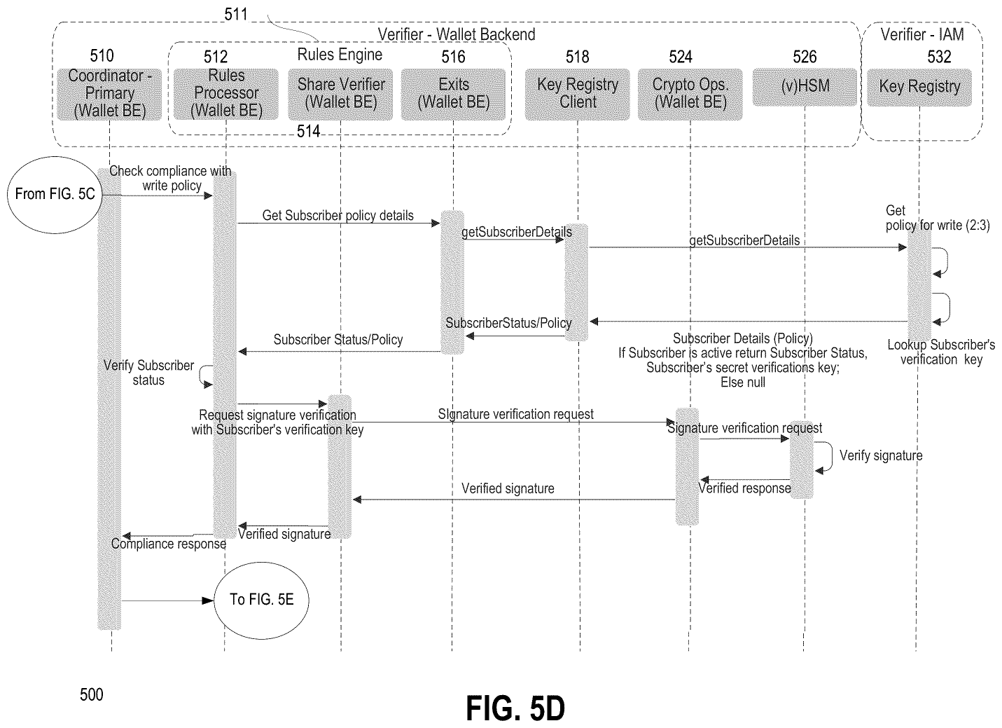

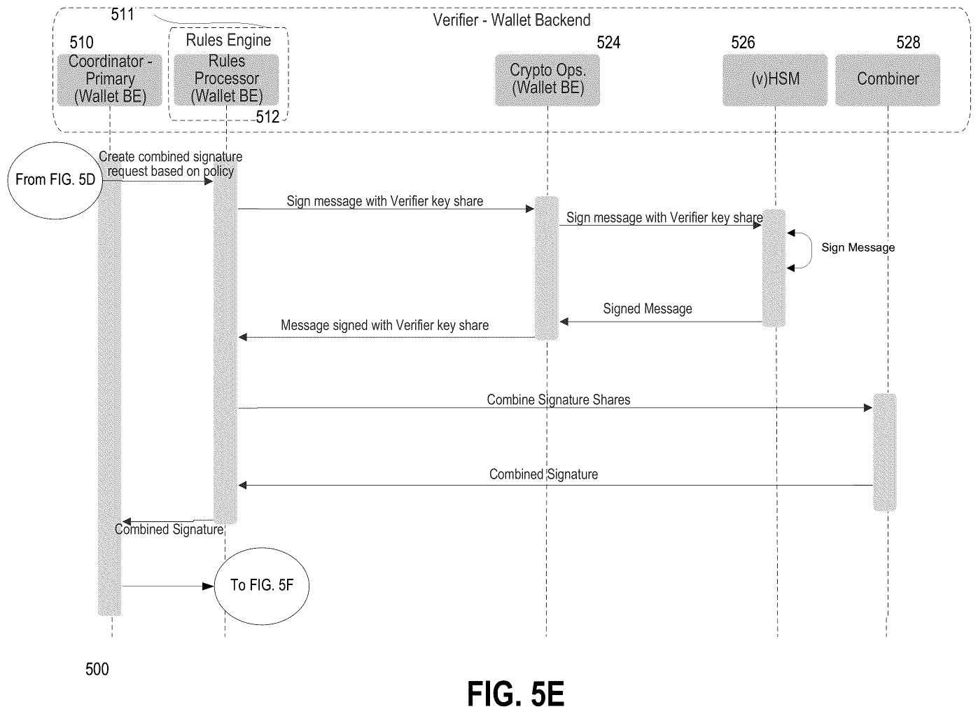

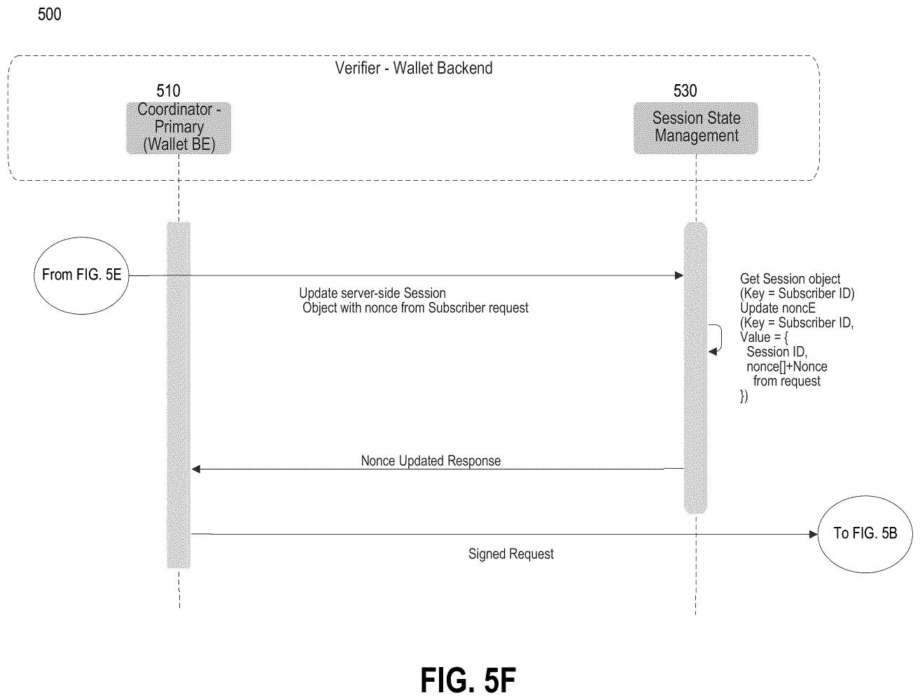

FIG. 5A, FIG. 5B, FIG. 5C, FIG. 5D, FIG. 5E, and FIG. 5F show a method diagram showing a sequence for a write-only signing and verification with authentication flow that is initiated by a subscriber, according to some embodiments. This includes an initial signing flow, as well as a verification flow. This example write-only signing can be considered a “heavyweight” flow, and as noted earlier in respect of Verifier 104 in FIG. 1, different flavors of heavyweight are possible where there are multiple Verifier 104s or Subscriber Proxy 106. Each increased Verifier 104 and/or Subscriber Proxy 106 introduces significant complexity to the flow, which is useful as a mechanism for opportunistically increasing cybersecurity resilience whenever computational resources become available.

In method 500, an approach is proposed where a Subscriber 102 works with a Verifier 104's wallet backend to obtain access to a protected resources on the backend for ultimately providing a write transaction processing to generate a response object in response to the Subscriber 102.

This method is initiated by the Subscriber using the Mobile App 502. The Mobile App 502 retrieves a Session ID and Subscriber ID from the Secure Enclave 508, or conditionally obtains these values from an Authentication flow if they are not defined. A new nonce value is obtained via the Wallet FE Crypto Ops Module 506, using the Secure Enclave 508, and these values are used to sign a write request.

In this embodiment, the write request is transmitted to a protected backend resource, the Target App Server 534, which verifies the operation is write request, before passing the operation on to the Wallet BE Coordinator Primary 510. This then proceeds to validate the session, using the Session Validator 520, which is able to get session state from the Session State Management 530.

This method, according to some embodiments, will then use the Rules Engine 511 to check compliance with a read policy, such Rules Engine consisting of a Rules Processor 512, a Share Verifier 514, and an Exits 516 module. These interact with the Key Registry Client 518 to get subscriber details, which is in turn able to look up those details in an IAM Verifier Key Registry 532. The lookup response from this latter service will indicate whether the user is inactive, which is indicated using a null response. The Rules Engine 511 also interacts with the Wallet BE Crypto Ops 524, and the (vHSM) 526 to verify the subscriber's signature.

In this method, the Rules Engine 511 then acts to create a combined signature request based on the write policy. This is done by signing the message with the Verifier Key Share, using the Wallet BE Crypto Ops 524 and the (vHSM) 526. The Combiner 528 then acts to combine signature shares, and returns a combined signature to the Rules Engine 511. This combined signature can then be returned to the Wallet BE Coordinator Primary 510.

Finally, the Wallet BE Coordinator Primary 510 updates the Session State Management 530 with an updated Session Object, which might include for example nonce details from the user request. The Signature verification response can be returned to the Target App Server 534, which can then process the write transaction.

When running the write request, the Target App Server 534 is able to verify the combined signature by submitting a Combined Signature Verification Request to the Signature Verifier 522. This uses the Wallet BE Crypto Ops 524 and the (vHSM) 526 to verify the combined signature, and pass a Verified Signature response back to the Target App Server. The server is able to complete the write request, and return a response to the Mobile app 502.

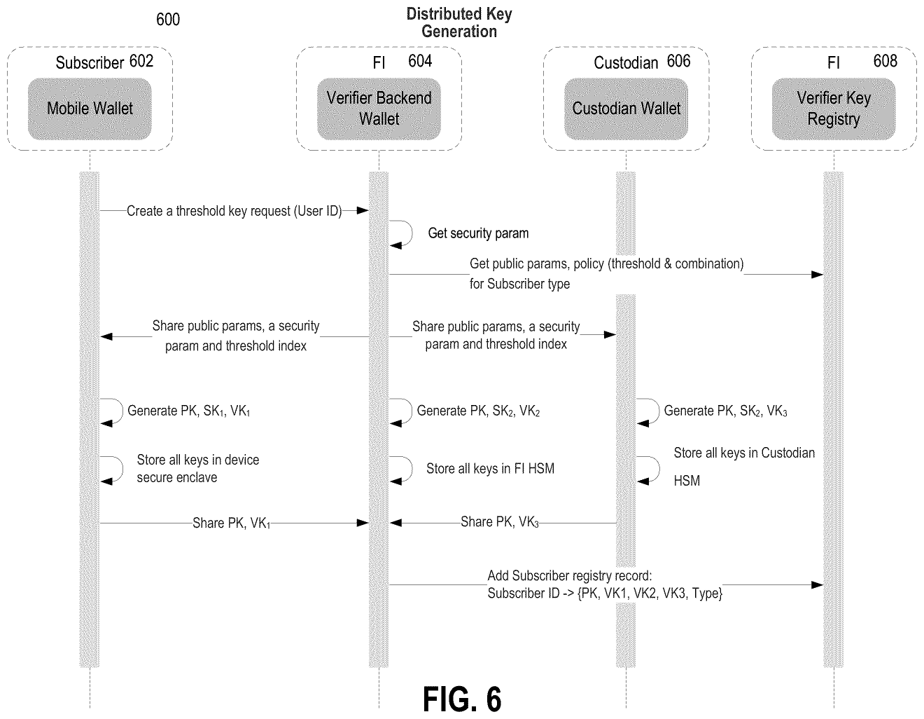

FIG. 6 is a method diagram for a Distributed Key Generation flow, according to some embodiments. Method 600 allows a Subscriber Mobile Wallet 602 to securely generate a set of keys, with a record of this set store to a Verifier Key Registry 608. The method begins with the Subscriber Mobile Wallet 602 generating a threshold key request, using the Subscriber's ID. This is sent to the Verifier Backend Wallet 604, which gets a Security Parameter, and which looks up public parameters and policies from the Verifier Key Registry 608. These are then shared both with the Subscriber Mobile Wallet 602 and the Custodian Wallet 606.

Each of the Subscriber Mobile Wallet 602, the Verifier Backend Wallet 604, and the Custodian Wallet 606 are then able to generate a key set, and each then stores its respective keyset locally. The keyset may include a private key, a shared key, and a verification key. The Subscriber Mobile Wallet 602 and Custodian Wallet 606 share their public and verification keys with the Verifier Backend Wallet 604, which in turn saves a record of the public and verifier keys to the Verifier Key Registry 608.

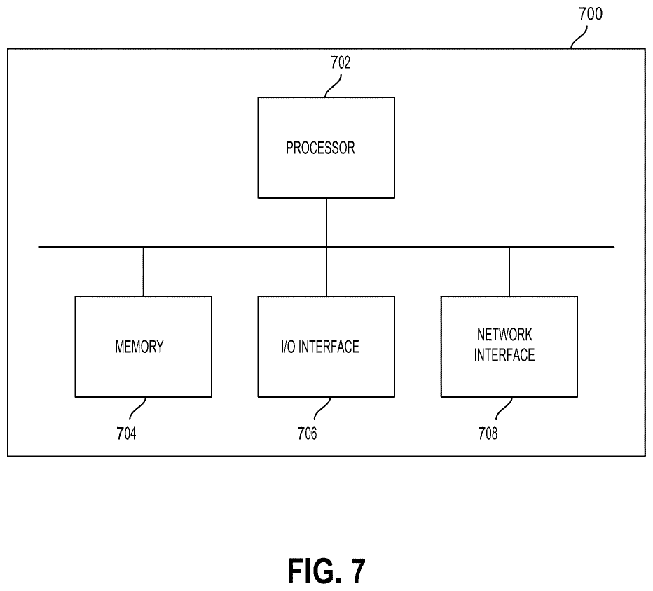

FIG. 7 is a computer system diagram showing an example computer device that can be used to implement some of the claimed embodiments. The computer system is a computer server that operates as a Verifier 104 computing system, for example, and can be a computing node that includes a computer processor 702, which is a physical computer microprocessor that is coupled to operate with corresponding computer memory 704, and input/output interface 706, and a network interface 708 that can be utilized for interacting with other computer systems and components through, for example, a message bus for exchanging data messages.

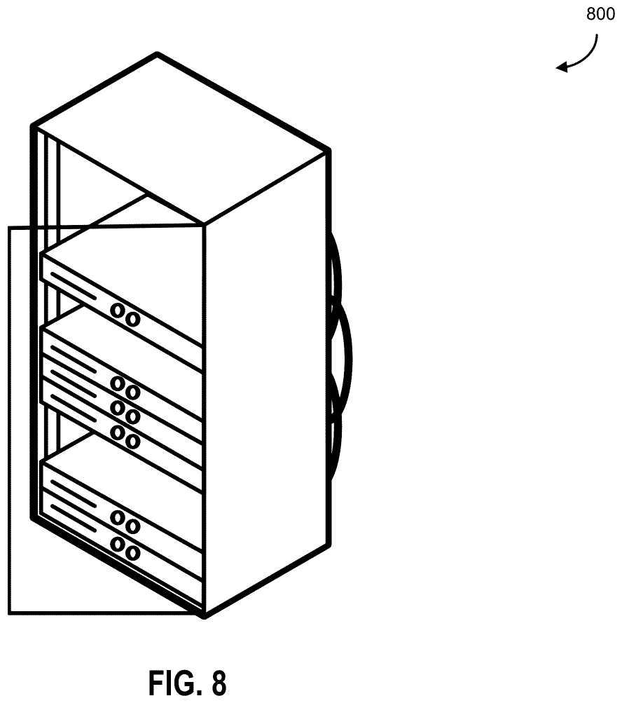

FIG. 8 is an example special purpose machine 800 that can be transformed using machine interpretable instruction sets, according to some embodiments.

In practical implementation, a multi party coordination mechanism is provided that can be used to provide scalable approaches for practically adapting cybersecurity requirements as a mechanism to opportunistically harden certain verifications where computing processing power is either idle or estimated to be available through system monitoring. The approach extends and augments a proposed MPC solution to support enterprise scalable cybersecurity requirements through intelligent coordination of policies where dynamic hardening is available through selecting between different flavors of lightweight and heavyweight crypto operations, improving the operation of the overall computing system taking into consideration finite computing resources.

As described in various embodiments noted above, while the system is not infallible, a dynamic increase in cybersecurity hardening that is conducted opportunistically significantly reduces vulnerabilities to effectively hide verifications that could have single point of failure where the approach can opportunistically increase security to require multi-signatures to get multi-party verification at a higher computational cost. The higher computational cost is managed through a corresponding load tracking mechanism that is used to estimate whether idle computing capabilities are available. The system, through effectively sharding the verification process, can also be used for key re-generation to reduce the impact of non-maliciously lost keys.

As noted herein, a practical implementation use case can be a multi-party cryptographic messaging system adapted for coordinating data messages between a subscriber device, one or more verifier devices, and a subscriber proxy device. These devices can be used, in a non-limiting example, to establish a decentralized online banking system. In this example decentralized online banking system, there are different types of operations available, such as querying an account balance (low impact), transferring funds between accounts of a same user (low impact), transferring funds to accounts of a trusted user (medium impact), and transferring funds to an untrusted user's account (high impact). The subscriber in this example is the banking user, the proxy can be a trusted third party verifier, such as a government service, an audit service, a paid “trusted friend” service, and the verifier devices can be those associated with a financial institution.

In this example, they all operate through a combination digital wallet front end and backend application where they are able to conduct activities associated with the transaction. Each transaction can require n verifications, and there may be m computing parties in this example. Each of the subscriber, the subscriber proxy, and verifier instances can be a party having corresponding cryptographic keys that can be used for signing (total parties=m).

The total number of signatures required can either utilize a lightweight “read-only” type of verification, or a heavyweight “write” type of verification. While the lightweight verification only requires verification of a single key (e.g., just that of the subscriber), all of the heavyweight verifications require at least two verifications, and in some embodiments, specific combinations are required. Each of the heavyweight verifications can be considered a different weight—for example 2/5 can be light heavyweight, 3/5 can be medium heavyweight, 4/5 can be heavy heavyweight, and 5/5 can be super heavyweight. Each increase in weight has a corresponding increase in computational complexity and needs to be adapted sparingly.

When a new verification is required, for example, for the different operations noted above, querying an account balance (low impact), transferring funds between accounts of a same user (low impact), transferring funds to accounts of a trusted user (medium impact), and transferring funds to an untrusted user's account (high impact), each of these can be assigned a minimum verification requirement. In this example: querying an account balance (1+), transferring funds between accounts of a same user (1+), transferring funds to accounts of a trusted user (2+), and transferring funds to an untrusted user's account (5). The specific minimum requirement can be set by interrogating the data object of the verification in conjunction with a policy requirement, such as comparing against a policy table stored in memory.

A coordination engine device is provided that acts as a selecting dynamic security increase engine that automatically improves security using opportunistic idle computing, acting as a opaque hardening layer that modifies the +aspects of the verification requirements. The coordination engine processor modifies these aspects by effectively controlling routing the verification requests to different smart contract based verification processes each having a different number of cryptographic signatures required for verification. The coordination engine processor can be API coupled to all of the smart contract based verification processes and selectively determines which API to utilize for verifications.

The increasing of “weight” can be conducted in different approaches. In a simpler approach, every incoming verification, where load is still determined to be low, can be increased by one in terms of weight. However, in more complex variations, a probabilistic function can be applied to introduce a level of randomness and “jitter” to the weight increases. For example, while load is low, 30% of verifications where there is room for weight increases have their weights increased. The weight increase quantum can also be randomly upgraded based on a probabilistic distribution (e.g., 95% are increased by one weight, 4% are increased by two weights, and 1% are increased by three or more weights).

Accordingly, the increased computational burden can be spread out across a larger number of verifications in these examples, and from an attacker's perspective, this randomized hardening may make it difficult to estimate the total amount of resources required to mount an effective cyber attack, such as a denial of service attack, etc. Because it will not be readily apparent how many signatures need to be broken for an attack to be effective, the effective cybersecurity vulnerability vector can be reduced. As a specific example, an attacker may be looking to compromise a simple account balance check, which could be a 1/5 weight check, requiring enough attacker resources to overwhelm a single device.

However, the coordination engine is configured to automatically utilize countermeasures to frustrate this by opportunistically raising the weight of the verification to 2/5, 3/5, 4/5, or even 5/5, and the attack may thus fail despite having seemingly having enough resources to overwhelm a single device. As computational resources are finite and recognizing that these hardening approaches can become significantly expensive, as noted herein, the random probabilistic distribution approach is a technically useful compromise mechanism to spread out hardening across different verifications. These automatic countermeasures implemented by the coordination engine provide a useful and practical mechanism on a digital wallet backend to address cybersecurity weaknesses while balancing performance requirements (e.g., having everything at a maximum verification requirement weight could otherwise throttle throughput to an unacceptable level of performance).

For a verification request requiring at least a minimum number of cryptographic signatures, the verification request is routed to a smart contract based verification process requiring a number of cryptographic signatures greater than the minimum number of cryptographic signatures if the coordination engine processor, based at least on an input load measurement, determines that there is available idle computing processing power. Load can be lower during periods where the system is less popular from a transactional perspective, such as overnight, on weekends, etc., and can be higher during popular transaction periods.

The coordination engine processor stores, on an associated data storage, a representation of a target cryptographic complexity level as tracked by a ratio of routing between smart contract based verification processes requiring a single verification and smart contract based verification processes requiring a plurality of verifications, a minimum ratio is maintained by opportunistically requiring a number of cryptographic signatures greater than the minimum number of cryptographic signatures if the coordination engine processor if the ratio is below a target ratio. This ratio can be a ratio of at least 1:5 lightweight to heavyweight verifications, and in some embodiments, the ratio can be more granularly established on a per type of transaction basis, or different heavyweight weights can contribute proportionately to the ratio determination. Accordingly, even if the system is under heavy load, a minimum cybersecurity level can be enforced by the system (potentially having performance impacts).

The coordination engine processor can be further configured to modify the ratio based on the input load measurement, increasing the ratio when the input load measurement is low, and decreasing the ratio when the input load measurement is high, but the ratio is maintained to be at least a baseline ratio. The ratio can thus be adaptive, opportunistically using processing power where estimated to be available, but automatically releasing it in response to sensed load increases (so that overall transaction throughput is at least maintained at a satisfactory level).

The input load measurement can be estimated based on a number of verifications being concurrently processed by the system (e.g., 10 transactions per minute as opposed to 10000 transactions per minute). The input load measurement is estimated, in an alternative approach, based on a monitored physical performance metric of the verifier device processor (e.g., 90% load->ratio decrease, 10% load->ratio increase). In another variant, the input load measurement is estimated based on a monitored network performance metric of the verifier device processor (e.g., based on total transaction time required for a sample transaction to go through).

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

As can be understood, the examples described above and illustrated are intended to be exemplary only.

What is claimed is:

1. A multi-party cryptographic messaging system adapted for coordinating data messages between a subscriber device, one or more verifier devices, and a subscriber proxy device, the system comprising:
a subscriber device including at least a subscriber device processor, a subscriber device secure processing enclave, the subscriber device processor configured for maintaining a mobile application providing a digital wallet frontend application;
a verifier device including at least a verifier device processor, a verifier device secure processing enclave, the verifier device processor configured for maintaining a digital wallet backend application;
a subscriber proxy device including at least a subscriber proxy device processor, a subscriber proxy device secure processing enclave; the subscriber proxy device processor configured for processing verification requests received from the verifier device based on one or more authorizations stored on the subscriber proxy device secure processing enclave from the subscriber device; and
a coordination engine device including at least a coordination engine processor configured to control routing of the verification requests to different smart contract based verification processes each having a different number of cryptographic signatures required for verification, wherein for a verification request requiring at least a minimum number of cryptographic signatures, the verification request is routed to a smart contract based verification process requiring a number of cryptographic signatures greater than the minimum number of cryptographic signatures if the coordination engine processor, based at least on an input load measurement, determines that there is available idle computing processing power.

2. The multi-party cryptographic messaging system of claim 1, wherein the coordination engine processor is further configured to store, on an associated data storage, a representation of a target cryptographic complexity level as tracked by a ratio of routing between smart contract based verification processes requiring a single verification and smart contract based verification processes requiring a plurality of verifications, a minimum ratio is maintained by opportunistically requiring a number of cryptographic signatures greater than the minimum number of cryptographic signatures if the coordination engine processor if the ratio is below a target ratio.

3. The multi-party cryptographic messaging system of claim 2, wherein the coordination engine processor is further configured to modify the ratio based on the input load measurement, increasing the ratio when the input load measurement is low, and decreasing the ratio when the input load measurement is high.

4. The multi-party cryptographic messaging system of claim 3, wherein the ratio is maintained to be at least a baseline ratio.

5. The multi-party cryptographic messaging system of claim 3, wherein the input load measurement is estimated based on a number of verifications being concurrently processed by the system.

6. The multi-party cryptographic messaging system of claim 3, wherein the input load measurement is estimated based on a monitored physical performance metric of the verifier device processor.

7. The multi-party cryptographic messaging system of claim 3, wherein the input load measurement is estimated based on a monitored network performance metric of the verifier device processor.

8. The multi-party cryptographic messaging system of claim 1, wherein coordination engine processor is configured to determine the minimum number of cryptographic signatures for a verification based on a processing of a data object associated with the verification storing characteristics of an operation coupled to the verification.

9. The multi-party cryptographic messaging system of claim 8, wherein the minimum number of cryptographic signatures for verifications associated with crypto asset transfers always require at least a plurality of verifications.

10. The multi-party cryptographic messaging system of claim 1, wherein the subscriber device secure processing enclave, the verifier device secure processing enclave, and the subscriber proxy device secure processing enclave store digital keys on corresponding memory which are not accessible directly by the corresponding processors.

11. A multi-party cryptographic messaging method for coordinating data messages between a subscriber device, one or more verifier devices, and a subscriber proxy device, the method comprising:
controlling routing of the verification requests to different smart contract based verification processes each having a different number of cryptographic signatures required for verification, wherein for a verification request requiring at least a minimum number of cryptographic signatures, the verification request is routed to a smart contract based verification process requiring a number of cryptographic signatures greater than the minimum number of cryptographic signatures if the coordination engine processor, based at least on an input load measurement, determines that there is available idle computing processing power.

12. The multi-party cryptographic messaging method of claim 11, further comprising storing, on an associated data storage, a representation of a target cryptographic complexity level as tracked by a ratio of routing between smart contract based verification processes requiring a single verification and smart contract based verification processes requiring a plurality of verifications, a minimum ratio is maintained by opportunistically requiring a number of cryptographic signatures greater than the minimum number of cryptographic signatures if the coordination engine processor if the ratio is below a target ratio.

13. The multi-party cryptographic messaging method of claim 12, further comprising modifying the ratio based on the input load measurement, increasing the ratio when the input load measurement is low, and decreasing the ratio when the input load measurement is high.

14. The multi-party cryptographic messaging method of claim 13, wherein the ratio is maintained to be at least a baseline ratio.

15. The multi-party cryptographic messaging method of claim 13, wherein the input load measurement is estimated based on a number of verifications being concurrently processed by the system.

16. The multi-party cryptographic messaging method of claim 13, wherein the input load measurement is estimated based on a monitored physical performance metric of the verifier device processor.

17. The multi-party cryptographic messaging method of claim 13, wherein the input load measurement is estimated based on a monitored network performance metric of the verifier device processor.

18. The multi-party cryptographic messaging method of claim 11, further comprising determining the minimum number of cryptographic signatures for a verification based on a processing of a data object associated with the verification storing characteristics of an operation coupled to the verification.

19. The multi-party cryptographic messaging method of claim 18, wherein the minimum number of cryptographic signatures for verifications associated with crypto asset transfers always require at least a plurality of verifications.

20. A non-transitory computer readable medium storing machine interpretable instruction sets, which when executed by a processor, cause the processor to perform steps of a multi-party cryptographic messaging method for coordinating data messages between a subscriber device, one or more verifier devices, and a subscriber proxy device, the method comprising:
controlling routing of the verification requests to different smart contract based verification processes each having a different number of cryptographic signatures required for verification, wherein for a verification request requiring at least a minimum number of cryptographic signatures, the verification request is routed to a smart contract based verification process requiring a number of cryptographic signatures greater than the minimum number of cryptographic signatures if the coordination engine processor, based at least on an input load measurement, determines that there is available idle computing processing power.
